(19) United States
(12) Patent Application Publication
(10) Pub. No.: US 2013/0176197 A1
(43) Pub. Date: Jul. 11, 2013

(54) DISPLAY DRIVING APPARATUS AND METHOD FOR DRIVING DISPLAY PANEL

(71) Applicant: Novatek Microelectronics Corp., Hsinchu (TW)

(72) Inventor: Jen-Chieh Hu, Kaohsiung City (TW)

(73) Assignee: NOVATEK MICROELECTRONICS CORP., Hsinchu (TW)

(21) Appl. No.: 13/736,069

(22) Filed: Jan. 8, 2013

(30) Foreign Application Priority Data
Jan. 9, 2012 (TW) 101100821

(51) Int. Cl. G09G 3/36

(52) U.S. Cl. CPC G09G 3/36
USPC 345/87

(57) ABSTRACT

A display driving apparatus for driving a display panel is disclosed. The display driving apparatus includes a controller, a source driving circuit, and a gate driving circuit. The controller receives a display data and enables a specific driving mode when the display data is a specific display mode data. The source driving circuit generates a plurality of source driving signals. When the specific driving mode is enabled, the source driving circuit makes each source driving signal to hold at a DC driving voltage during a first sub-frame period of a frame period and at another DC driving voltage during a second sub-frame period of the frame period. When the specific driving mode is enabled, the gate driving circuit masks a first part of a plurality of gate scanning signals during the first sub-frame period and masks a second part of the gate scanning signals during the second sub-frame period.

### CROSS-REFERENCE TO RELATED APPLICATION

This application claims the priority benefit of Taiwan application serial no. 101100821, filed on Jan. 9, 2012. The entirety of the above-mentioned patent application is hereby incorporated by reference herein and made a part of this specification.

### BACKGROUND OF THE INVENTION

1. Field of the Invention

The invention generally relates to a display driving apparatus and a method for driving a display panel, and more particularly, to a liquid crystal display (LCD) driving apparatus and a method for driving a display panel.

2. Description of Related Art

FIG. 1A is a diagram of a conventional liquid crystal display (LCD) device 100. Referring to FIG. 1A, the LCD panel 110 of the LCD device 100 includes a plurality of pixels arranged into an array, and the LCD panel 110 is driven according to gate scanning signals G1-G4 and source driving signals SN1 and SN2. In the conventional LCD device 100, the gate scanning signals G1-G4 are sequentially activated (i.e., boosted to a high voltage level) during a frame period to sequentially turn on the thin film transistors (TFTs) corresponding to the pixels on the LCD panel 110. The source driving signals SN1 and SN2 produce corresponding voltage values according to the grayscale values to be displayed in response to the activation of the gate scanning signals G1-G4.

FIG. 1B illustrates waveforms of the source driving signals SN1 and SN2. Referring to both FIG. 1A and FIG. 1B, if horizontal lines are to be displayed on the LCD panel 110, the source driving signal SN1 needs to periodically transition between the positive driving voltages V11 and V91 in response to the activation of the gate scanning signals G1-G4, and contrarily, the source driving signal SN2 needs to periodically transition between the negative driving voltages V12 and V92 in response to the activation of the gate scanning signals G1-G4, wherein the driving voltages V11 and V92 allow the corresponding pixels to be brightened. The constant transition of the source driving signals SN1 and SN2 causes the power consumption of the LCD device 100 to increase drastically and increases the temperature of the LCD device 100. As a result, the efficiency of the LCD device 100 is seriously impacted.

### SUMMARY OF THE INVENTION

Accordingly, the invention is directed to a display driving apparatus and a method for driving a display panel, in which the power consumption is effectively reduced.

The invention provides a display driving apparatus for driving a display panel. The display driving apparatus includes a controller, a source driving circuit, and a gate driving circuit. The controller receives a display data and enables a specific driving mode when the display data is a specific display mode data. The source driving circuit is coupled to the controller and the display panel. The source driving circuit generates a plurality of source driving signals. When the specific driving mode is enabled, the source driving circuit makes each of the source driving signals to hold at one of a plurality of DC driving voltages during a first sub-frame period of a frame period and hold at another one of the DC driving voltages during a second sub-frame period of the frame period. The gate driving circuit is coupled to the controller and the display panel. The gate driving circuit generates a plurality of gate scanning signals. When the specific driving mode is enabled, the gate driving circuit masks a plurality of first part gate scanning signals among the gate scanning signals during the first sub-frame period and masks a plurality of second part gate scanning signals other than the first part gate scanning signals during the second sub-frame period.

The invention also provides a method for driving a display panel. The method includes following steps. A display data is received, and a specific driving mode is enabled when the display data is a specific display mode data. In the specific driving mode, each of a plurality of source driving signals is made to hold at one of a plurality of DC driving voltages during a first sub-frame period of a frame period and hold at another one of the DC driving voltages during a second sub-frame period of the frame period. A plurality of gate scanning signals is generated, and in the specific driving mode, a plurality of first part gate scanning signals among the gate scanning signals is masked during the first sub-frame period, and a plurality of second part gate scanning signals other than the first part gate scanning signals is masked during the second sub-frame period.

As described above, in a display driving apparatus disclosed by the invention, when a display data is a specific display mode data for displaying a specific image, a specific driving mode is enabled and source driving signals are maintained at DC driving voltages during sub-frame periods. Thereby, the number of transitions of the source driving signals during the same frame period is greatly reduced, and accordingly the power consumption is effectively reduced.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a conventional liquid crystal display (LCD) device 100.

FIG. 1B illustrates waveforms of source driving signals SN1 and SN2.

FIG. 2 is a diagram of a display driving apparatus 200 according to an embodiment of the invention.

FIG. 3A and FIG. 3B are diagrams of specific display images.

FIGS. 4A-6 illustrate different driving waveforms of the display driving apparatus 200.

FIG. 7 is a flowchart of a method for driving a display panel according to an embodiment of the invention.

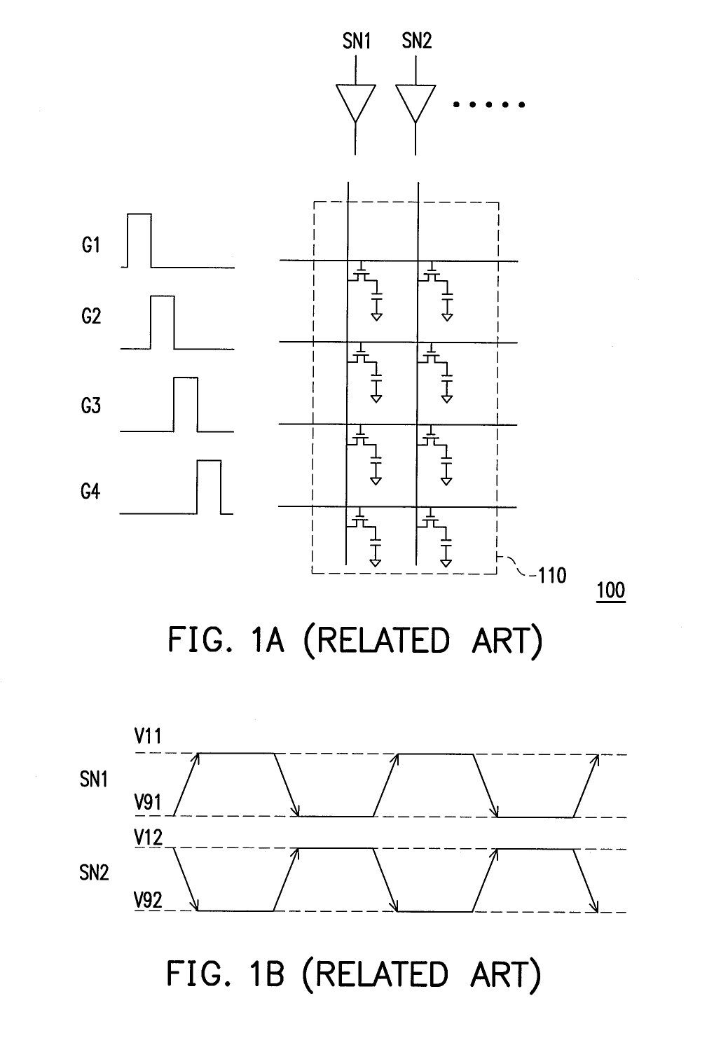

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

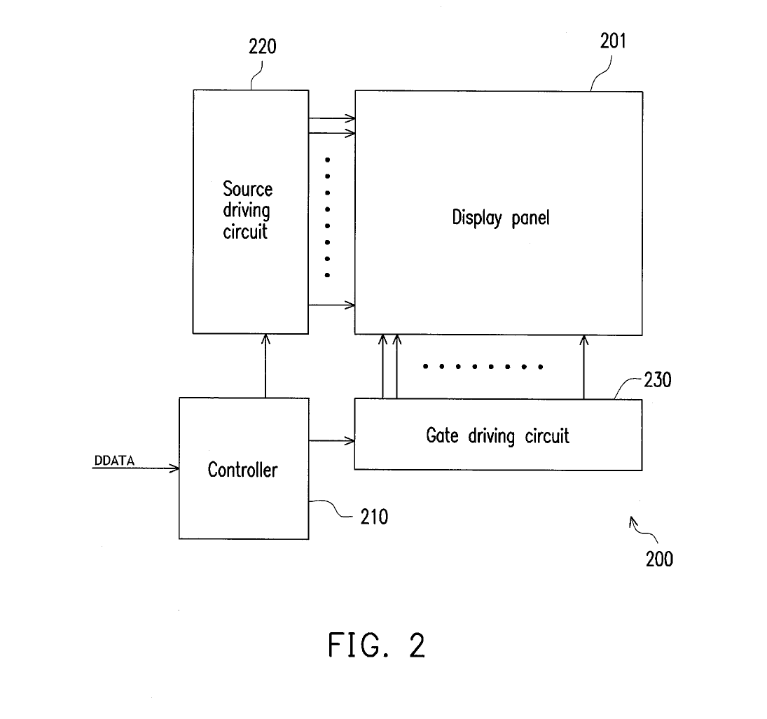

FIG. 2 is a diagram of a display driving apparatus 200 according to an embodiment of the invention. Referring to FIG. 2, the display driving apparatus 200 includes a controller 210, a source driving circuit 220, and a gate driving circuit 230. The display driving apparatus 200 is configured to drive a display panel 201. The controller 210 receives a display data DDATA and determines whether or not the display data DDATA is a specific display mode data corresponding to a specific display image. The controller 210 enables a specific driving mode when the display data DDATA is determined to be a specific display mode data.

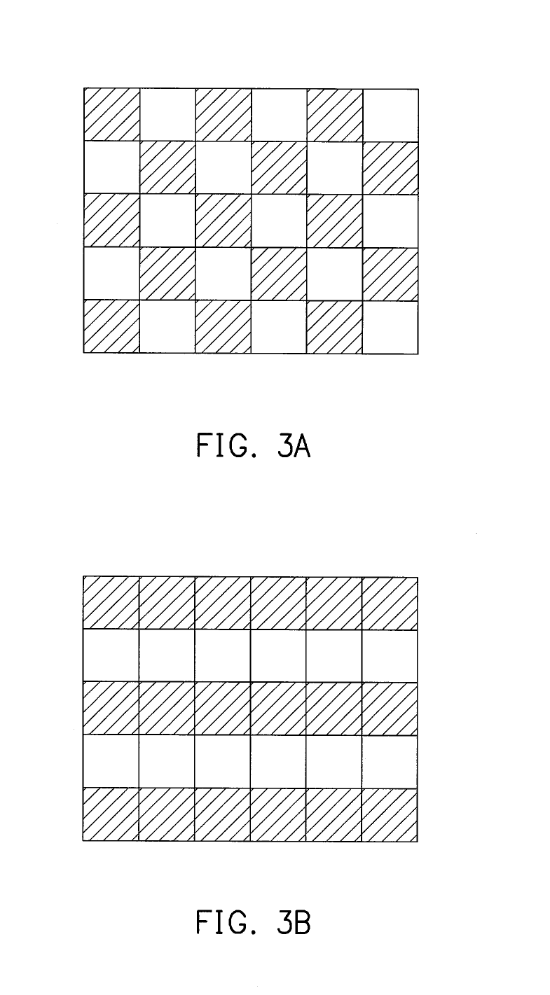

FIG. 3A and FIG. 3B are diagrams illustrating specific display images. To be specific, FIG. 3A is a diagram of a lattice image, and FIG. 3B is a diagram of a horizontal line image. In addition, a specific display image includes a completely dark image and a completely bright image (i.e., all pixels on the display panel 201 display dark spots or bright spots).

Referring to FIG. 2 again, the source driving circuit 220 is coupled to the controller 210 and the display panel 201. The source driving circuit 220 generates a plurality of source driving signals to drive the display panel 201. When the controller 210 enables the specific driving mode, each source driving signal generated by the source driving circuit 220 is maintained at one of a plurality of DC driving voltages during a first sub-frame period of a frame period and is maintained at another one of the DC driving voltages during a second sub-frame period of the same frame period. In addition, the gate driving circuit 230 is coupled to the controller 210 and the display panel 201. The gate driving circuit 230 generates a plurality of gate scanning signals to scan the display panel 201. When the controller 210 enables the specific driving mode, the gate driving circuit 230 masks a plurality of first part gate scanning signals among the gate scanning signals during the first sub-frame period and masks a plurality of second part gate scanning signals other than the first part gate scanning signals during the second sub-frame period.

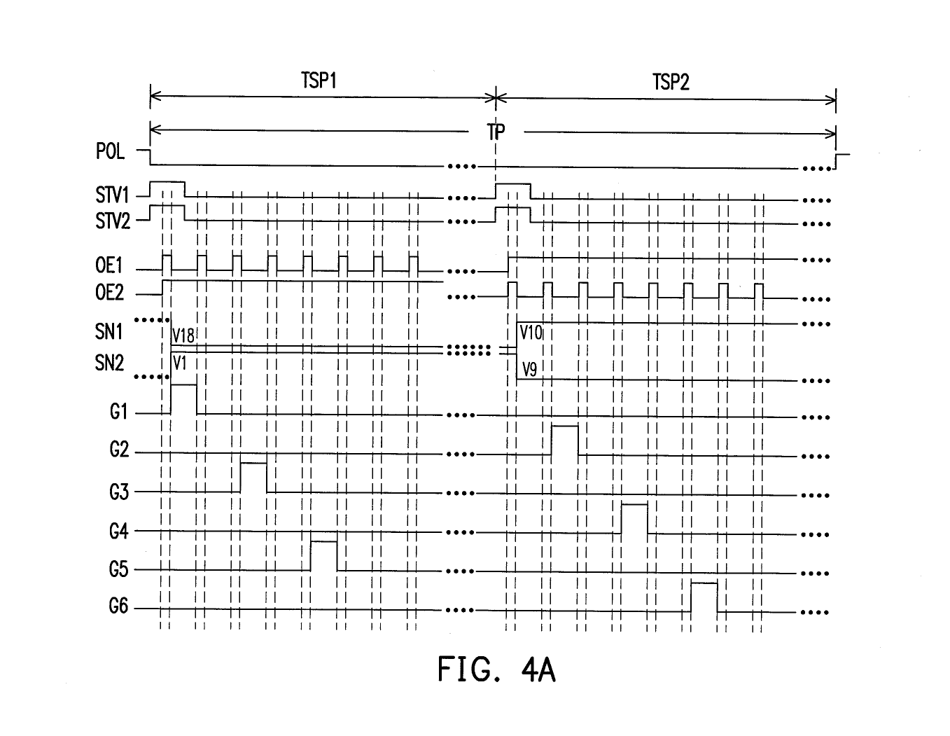

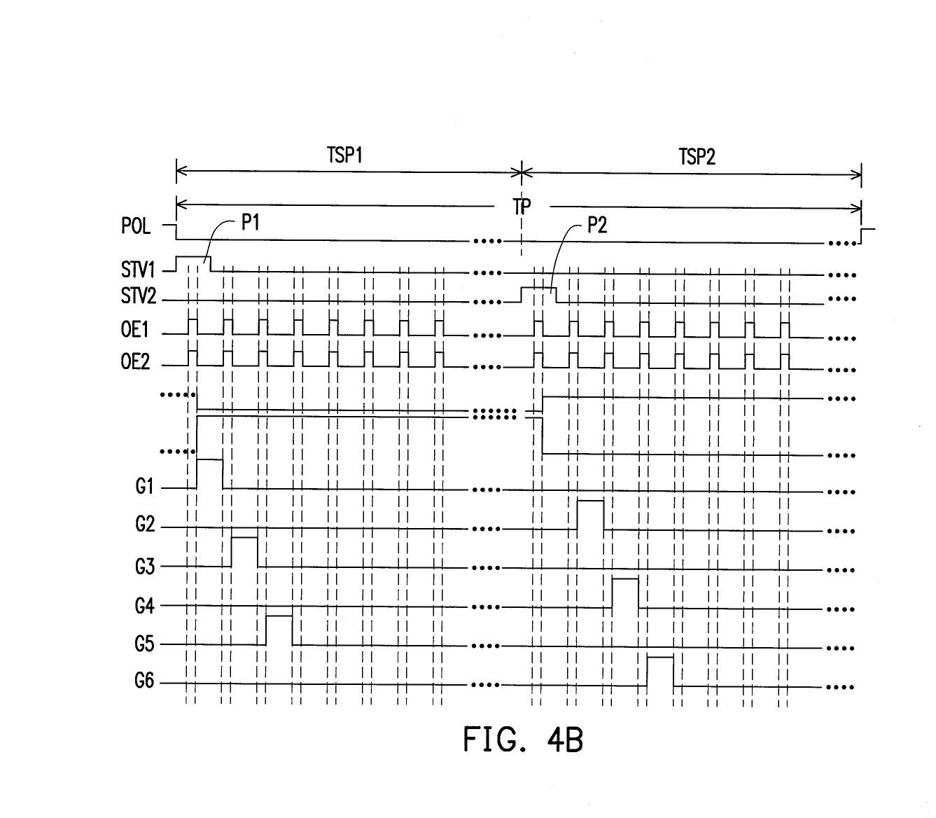

The operation of the display driving apparatus 200 in the present embodiment will be described with reference to both FIG. 2 and FIG. 4A. FIG. 4A illustrates a driving waveform of the display driving apparatus 200. During a frame period TP, a polarity signal POL is maintained at a low level. The frame period TP includes a first sub-frame period TSP1 and a second sub-frame period TSP2. In addition, start pulse signals STV1 and STV2 are respectively provided at the beginning of the first sub-frame period TSP1 and the beginning of the second sub-frame period TSP2 to respectively activate the scanning operation of the odd number gate scanning signals G1, G3, and G5 and the even number gate scanning signals G2, G4, and G6.

Moreover, the mask enabling signals OE1 and OE2 are respectively used for masking the scanning action of the odd number gate scanning signals G1, G3, and G5 and the even number gate scanning signals G2, G4, and G6. To be specific, when the mask enabling signal OE1 is at a logic high level, the effect for activating (boosting to a high voltage level) the gate scanning signals G1, G3, and G5 is masked. Contrarily, when the mask enabling signal OE2 is at a logic high level, the effect for activating (boosting to a high voltage level) the gate scanning signals G2, G4, and G6 is masked.

Referring to FIG. 4A, when the controller 210 detects that the display data DDATA is a specific display mode data used for displaying a horizontal line image, the controller 210 enables a specific driving mode and provides the mask enabling signals OE1 and OE2 correspondingly, as shown in FIG. 4A. It should be noted that during the first sub-frame period TSP1, the mask enabling signal OE1 holds a regular periodic pulse signal, while the mask enabling signal OE2 is a DC signal holding at a logic high level. Thus, during the first sub-frame period TSP1, the gate scanning signals G1, G3, and G5 keep their regular activation/deactivation actions while the gate scanning signals G2, G4, and G6 are masked therefore hold at a low voltage level (deactivated state). Contrarily, during the second sub-frame period TSP2, the mask enabling signal OE2 holds a regular periodic pulse signal, while the mask enabling signal OE1 is a DC signal holding at a logic high level. Thus, during the second sub-frame period TSP2, the gate scanning signals G2, G4, and G6 keep their regular activation/deactivation actions while the gate scanning signals G1, G3, and G5 are masked therefore hold at a low voltage level (deactivated state).

Additionally, the source driving signals SN1 and SN2 in FIG. 4A are respectively an odd number source driving signal and an even number source driving signal. Because a horizontal line image is displayed on the display panel 201, all the odd number source driving signals have the same waveform, and all the even number source driving signals also have the same waveform. For example, assuming that all the odd rows on the display panel 201 are lightened while none of the even rows is lightened, during the first sub-frame period TSP1, the source driving signals SN1 and SN2 respectively hold at DC driving voltages V18 and V1 to allow the pixels to present bright spots, and during the second sub-frame period TSP2, the source driving signals SN1 and SN2 respectively hold at DC driving voltages V10 and V9 to allow the pixels to present dark spots. Herein the DC driving voltages V18 and V1 are respectively driving voltages for lightening pixels at different driving polarities, and the DC driving voltages V10 and V9 are respectively driving voltages for darkening pixels at different driving polarities, wherein the DC driving voltages V1 and V9 have the same driving polarity, and the DC driving voltages V10 and V18 have the same driving polarity.

The source driving signals SN1 and SN2 are controlled to present different driving polarities during the same sub-frame period in order to accomplish an implementation of column inversion. However, the invention is not limited thereto, and the source driving signals SN1 and SN2 may not present different driving polarities during the same sub-frame period.

It can be understood based on foregoing description that with the driving waveform illustrated in FIG. 4A, a horizontal line image in which display rows corresponding to the gate scanning signals G1, G3, and G5 present bright spots while display rows corresponding to the gate scanning signals G2, G4, and G6 present dark spots can be effectively displayed on the display panel 201. Additionally, since the source driving signals SN1 and SN2 only transition while the sub-frame periods switch, the power consumption of the display driving apparatus 200 is effectively reduced.

FIG. 4B illustrates another driving waveform of the display driving apparatus 200. It can be understood by referring to FIG. 4B that the masking of part of the gate scanning signals may be accomplished without the mask enabling signal OE1 or OE2. In FIG. 4B, after the controller 210 enables the specific driving mode, it provides the start pulse signals STV1 and STV2 (as shown in FIG. 4B) to respectively mask the gate scanning signals G2, G4, and G6 or the gate scanning signals G1, G3, and G5.

To be specific, during the first sub-frame period TSP1, the controller 210 transmits a regular start pulse signal STV1 to the gate driving circuit 230 and provides a start pulse signal STV2 holding at a logic low level to the gate driving circuit 230. Accordingly, the gate driving circuit 230 generates regular gate scanning signals G1, G3, and G5 according to the pulse P1 of the start pulse signal STV1. However, since the start pulse signal STV2 has no effective pulse during the first sub-frame period TSP1, the gate driving circuit 230 cannot generate the gate scanning signals G2, G4, and G6 for sequential scanning. Accordingly, the gate scanning signals G2, G4, and G6 hold masked.

Contrarily, during the second sub-frame period TSP2, the controller 210 transmits a regular start pulse signal STV2 to the gate driving circuit 230 and provides a start pulse signal STV1 holding at a logic low level to the gate driving circuit 230. Accordingly, the gate driving circuit 230 generates regular gate scanning signals G2, G4, and G6 according to the pulse P2 of the start pulse signal STV2. However, since the start pulse signal STV1 has no effective pulse during the second sub-frame period TSP2, the gate driving circuit 230 cannot generate the gate scanning signals G1, G3, and G5 for sequential scanning. Accordingly, the gate scanning signals G1, G3, and G5 hold masked.

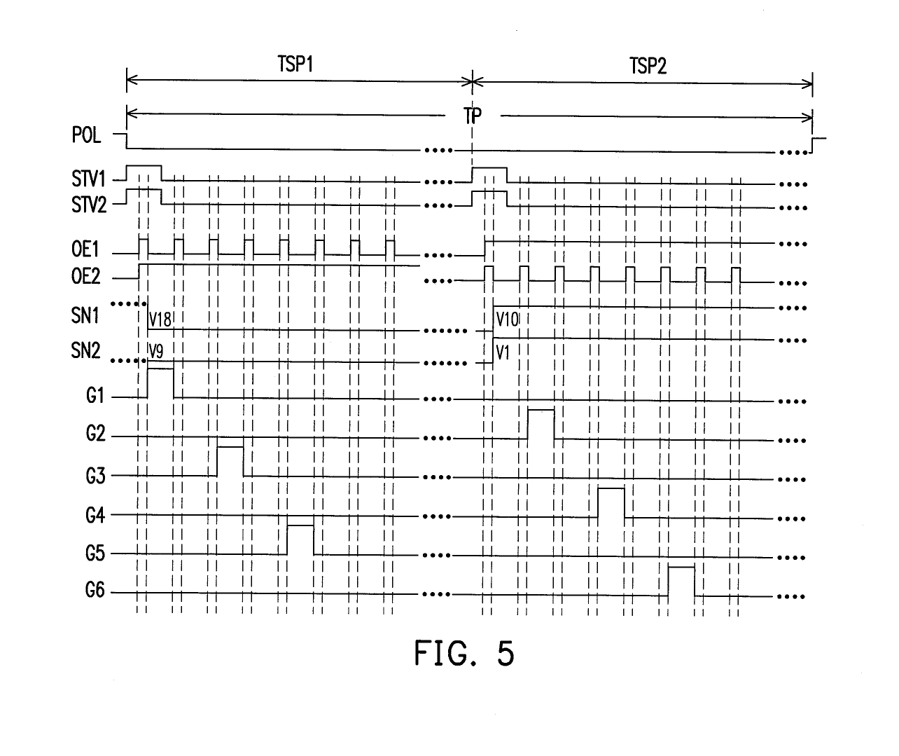

FIG. 5 illustrates another driving waveform of the display driving apparatus 200. FIG. 5 illustrates the driving waveform when a lattice image is displayed on the display panel 201. In this implementation, the gate scanning signals G1-G6 are controlled in a same way as that in the implementation illustrated in FIG. 4A therefore will not be described herein. Regarding the source driving signals SN1 and SN2, assuming that the source driving signal SN1 is an odd number source driving signal and the source driving signal SN2 is an even number source driving signal, during the first sub-frame period TSP1, the source driving signal SN1 holds at the DC driving voltage V18, and the source driving signal SN2 holds at the DC driving voltage V9. Namely, during the first sub-frame period TSP1, the odd number pixels in the rows corresponding to the gate scanning signals G1, G3, and G5 on the display panel 201 present bright spots, and the even number pixels in the rows corresponding to the gate scanning signals G1, G3, and G5 on the display panel 201 present dark spots.

During the second sub-frame period TSP2, the source driving signal SN1 holds at the DC driving voltage V10, and the source driving signal SN2 holds at the DC driving voltage V1. Namely, during the second sub-frame period TSP2, the odd number pixels in the rows corresponding to the gate scanning signals G2, G4, and G6 on the display panel 201 present dark spots, and the even number pixels in the rows corresponding to the gate scanning signals G2, G4, and G6 on the display panel 201 present bright spots. Thereby, a complete lattice image is displayed on the display panel 201.

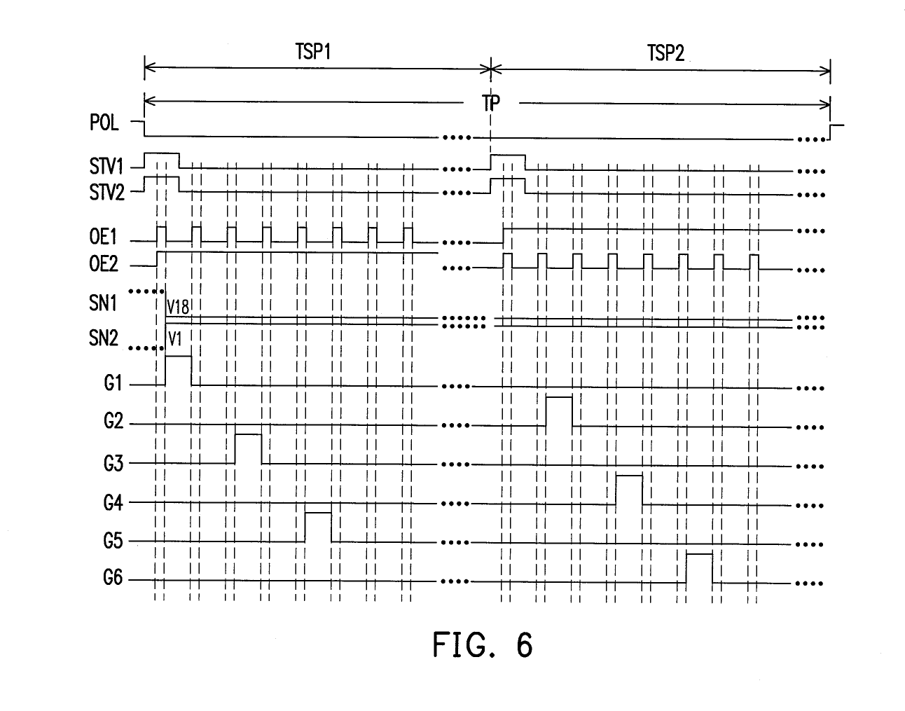

FIG. 6 illustrates another driving waveform of the display driving apparatus 200. FIG. 6 illustrates the driving waveform when a completely bright image is displayed on the display panel 201. During the first sub-frame period TSP1 and the second sub-frame period TSP2, the source driving signal SN1 always holds at the DC driving voltage V18 and the source driving signal SN2 always holds at the DC driving voltage V1. Thus, all the pixels on the display panel 201 always present bright spots. Accordingly, a completely bright image is displayed.

It should be mentioned that in order to prevent liquid crystal polarization, the source driving signals SN1 and SN2 are simply switched to respectively hold at the DC driving voltages V1 and V18 during the next frame period.

However, to display a completely dark image on the display panel 201, the source driving signal SN1 is controlled to hold at the DC driving voltage V10 or V9 during the same frame period, and the source driving signal SN2 is controlled to hold at the DC driving voltage V10 or V9 during the same frame period (the source driving signals SN1 and SN2 may not be the same). Thereby, all the pixels on the display panel 201 present dark spots and accordingly a completely dark image is displayed.

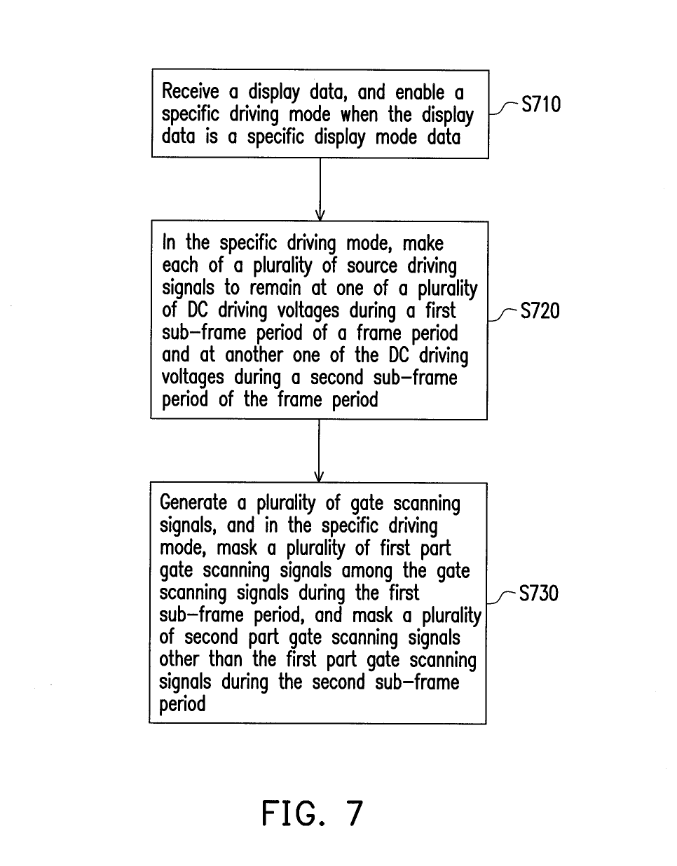

FIG. 7 is a flowchart of a method for driving a display panel according to an embodiment of the invention. Referring to FIG. 7, the method includes following steps. First, a display data is received, and a specific driving mode is enabled when the display data is a specific display mode data (S710). Then, in the specific driving mode, each of a plurality of source driving signals is maintained at one of a plurality of DC driving voltages during a first sub-frame period of a frame period and at another one of the DC driving voltages during a second sub-frame period of the frame period (S720). Additionally, a plurality of gate scanning signals is generated, and in the specific driving mode, a plurality of first part gate scanning signals among the gate scanning signals is masked during the first sub-frame period, and a plurality of second part gate scanning signals other than the first part gate scanning signals is masked during the second sub-frame period (S730). The implementation details of foregoing steps have been described in foregoing embodiments therefore will not be described herein.

As described above, in the invention, part of the gate scanning signals is masked during each sub-frame period, and a source driving signal is generated according to the unmasked gate scanning signals. In a specific driving mode, the number of transitions of the source driving signals, and accordingly the power consumption, is effectively reduced. Thereby, the performance of the display driving apparatus is improved.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A display driving apparatus, for driving a display panel, the display driving apparatus comprising:
a controller, receiving a display data, and enabling a specific driving mode when the display data is a specific display mode data;
a source driving circuit, coupled to the controller and the display panel and generating a plurality of source driving signals, wherein when the specific driving mode is enabled, the source driving circuit makes each of the source driving signals to hold at one of a plurality of DC driving voltages during a first sub-frame period of a frame period and hold at another one of the DC driving voltages during a second sub-frame period of the frame period; and
a gate driving circuit, coupled to the controller and the display panel and generating a plurality of gate scanning signals, wherein when the specific driving mode is enabled, the gate driving circuit masks a plurality of first part gate scanning signals among the gate scanning signals during the first sub-frame period and masks a plurality of second part gate scanning signals other than the first part gate scanning signals during the second sub-frame period.

2. The display driving apparatus according to claim 1, wherein the DC driving voltages comprise a plurality of positive driving voltages and a plurality of negative driving voltages.

3. The display driving apparatus according to claim 1, wherein the controller enables the specific driving mode when the controller determines that the display data is corresponding to a horizontal line image, a lattice image, a completely dark image, or a completely bright image.

4. The display driving apparatus according to claim 1, wherein the first part gate scanning signals are the gate scanning signals of odd numbers, and the second part gate scanning signals are the gate scanning signals of even numbers.

5. The display driving apparatus according to claim 1, wherein when the specific driving mode is enabled, the controller transmits a first mask enabling signal and a second mask enabling signal to the gate driving circuit, and the gate driving circuit masks the first part gate scanning signals according to the first mask enabling signal during the first sub-frame period and masks the second part gate scanning signals according to the second mask enabling signal during the second sub-frame period.

6. The display driving apparatus according to claim 1, wherein when the specific driving mode is enabled, the controller masks a first start pulse signal during the first sub-frame period and masks a second start pulse signal during the second sub-frame period.

7. The display driving apparatus according to claim 6, wherein when the specific driving mode is enabled, the gate driving circuit masks the first part gate scanning signals according to the masked first start pulse signal during the first sub-frame period and masks the second part gate scanning signals according to the masked second start pulse signal during the second sub-frame period.

8. The display driving apparatus according to claim 1, wherein when the specific driving mode is enabled, the source driving signals of even numbers have a same voltage level, and the source driving signals of odd numbers have a same voltage level.

9. A method for driving a display panel, comprising:
receiving a display data, and enabling a specific driving mode when the display data is a specific display mode data;
in the specific driving mode, making each of a plurality of source driving signals to hold at one of a plurality of DC driving voltages during a first sub-frame period of a frame period and at another one of the DC driving voltages during a second sub-frame period of the frame period; and
generating a plurality of gate scanning signals, and in the specific driving mode, masking a plurality of first part gate scanning signals among the gate scanning signals during the first sub-frame period, and masking a plurality of second part gate scanning signals other than the first part gate scanning signals during the second sub-frame period.

10. The method according to claim 9, wherein the DC driving voltages comprise a plurality of positive driving voltages and a plurality of negative driving voltages.

11. The method according to claim 9, wherein the step of enabling the specific driving mode when the display data is the specific display mode data comprises:
enabling the specific driving mode according to whether the display data is corresponding to a horizontal line image, a lattice image, a completely dark image, or a completely bright image.

12. The method according to claim 9, wherein the first part gate scanning signals are the gate scanning signals of odd numbers, and the second part gate scanning signals are the gate scanning signals of even numbers.

13. The method according to claim 9, wherein the step of “in the specific driving mode, masking the first part gate scanning signals among the gate scanning signals during the first sub-frame period and masking the second part gate scanning signals other than the first part gate scanning signals during the second sub-frame period” comprises:
when the specific driving mode is enabled, transmitting a first mask enabling signal and a second mask enabling signal to the gate driving circuit; and
masking the first part gate scanning signals according to the first mask enabling signal during the first sub-frame period, and masking the second part gate scanning signals according to the second mask enabling signal during the second sub-frame period.

14. The method according to claim 9, wherein the step of “in the specific driving mode, masking the first part gate scanning signals among the gate scanning signals during the first sub-frame period and masking the second part gate scanning signals other than the first part gate scanning signals during the second sub-frame period” comprises:
when the specific driving mode is enabled, masking a first start pulse signal during the first sub-frame period, and masking a second start pulse signal during the second sub-frame period; and
masking the first part gate scanning signals according to the masked first start pulse signal during the first sub-frame period, and masking the second part gate scanning signals according to the masked second start pulse signal during the second sub-frame period.

15. The method according to claim 9, wherein when the specific driving mode is enabled, the source driving signals of even numbers have a same voltage level, and the source driving signals of odd numbers have a same voltage level.
